(19) United States
(12) Patent Application Publication
(10) Pub. No.: US 2007/0152584 A1
(43) Pub. Date: Jul. 5, 2007

(54) Plasma display panel having reduced reflective brightness

(76) Inventors: Hyun Kim, Suwon-si (KR); Kyoung-Doo Kang, Suwon-si (KR); Se-Jong Kim, Suwon-si (KR); Yun-Hee Kim, Suwon-si (KR); Hyun Soh, Suwon-si (KR); Jin-Won Han, Suwon-si (KR)

Correspondence Address: CHRISTIE, PARKER & HALE, LLP, PO BOX 7068, PASADENA, CA, 91109-7068, US

(21) Appl. No.: 11/646,746

(22) Filed: Dec. 27, 2006

(30) Foreign Application Priority Data
Dec. 30, 2005 (KR) 10-2005-0135859

(51) Int. Cl. H01J 17/49

(52) U.S. Cl. 313/582

(57) ABSTRACT

A plasma display panel includes barrier ribs disposed between a front substrate and a rear substrate and define discharge cells. Sustain electrode pairs are disposed on the front substrate. Address electrodes are disposed on the rear substrate in a direction to cross the length direction of the sustain electrode pairs. A front dielectric layer covers the sustain electrode pairs, and has grooves formed in a direction parallel to the length direction of the sustain electrode pairs such that the grooves have slopes in a direction from the rear substrate towards the front substrate with ends of the sustain electrode pairs being located on a lower surface of the front substrate where shadows of the slopes are cast. A rear dielectric layer covers the address electrodes. Phosphor layers are coated in the discharge cells and a discharge gas fills the discharge cells.

### CROSS-REFERENCE TO RELATED PATENT APPLICATION

This application claims priority to and the benefit of Korean Patent Application No. 10-2005-0135859, filed on Dec. 30, 2005, in the Korean Intellectual Property Office, the entire content of which is incorporated herein by reference.

### BACKGROUND OF THE INVENTION

1. Field of the Invention

The present invention relates to a plasma display panel (PDP), and more particularly, to a PDP having reduced reflective brightness observed at the front of a panel.

2. Description of the Related Art

Recently, PDPs have drawn attention as a replacement for conventional cathode ray tube display devices. A PDP is a flat display panel that displays a desired image using visible light emitted though a process of exciting a phosphor material with ultraviolet rays generated from a discharge of a discharge gas filled between two substrates on which a plurality of electrodes are formed.

FIG. 1 is a vertical cross-sectional view of a structure of a conventional alternating current (AC) type PDP 10.

The conventional AC type PDP 10 includes an upper plate 50 where images are displayed and a lower plate 60 coupled parallel to the upper plate 50. A plurality of sustain discharge electrode pairs 12, each of which include a Y electrode 31 and an X electrode 32, are formed on a front substrate 11 of the upper plate 50.

A plurality of address electrodes 22 cross the Y electrode 31 and the X electrode 32 on a rear substrate 21 of the lower plate 60 facing the front substrate 11. Each of the Y electrode 31 and the X electrode 32 includes transparent electrodes 31a, 32a and bus electrodes 31b, 32b. A space formed by the pair of Y and X electrodes 31, 32 and the address electrodes 22 crossing the Y and X electrodes 31, 32 is a unit discharge cell which constitutes a discharge unit.

A front dielectric layer 15 and a rear dielectric layer 25 are respectively formed on surfaces of the front substrate 11 and the rear substrate 21. A protective layer 16 usually formed of MgO is formed on the front dielectric layer 15, and barrier ribs 30 that maintain a discharge distance and prevent electrical and optical crosstalk between the discharge cells are formed on the front surface of the rear dielectric layer 25. A phosphor layer 26 is coated on both sidewalls of the barrier ribs 30 and on a front surface of the rear dielectric layer 25 where the barrier ribs 30 are not formed.

In the above AC type PDP 10, light may be reflected at a front panel due to light entering the front panel. Accordingly, the AC type PDP 10 has low bright room contrast due to reflective brightness observed at the front panel.

### SUMMARY OF THE INVENTION

In accordance with the present invention PDP is provided that reduces reflective brightness observed at the front of a panel by increasing a ratio of a black portion at the front of the panel, thereby increasing bright room contrast.

According to an exemplary embodiment of the present invention, a PDP is provided having a rear substrate and a front substrate facing the rear substrate. Barrier ribs are disposed between the front substrate and the rear substrate and define a plurality of discharge cells. Sustain electrode pairs are disposed on a surface of the front substrate facing the rear substrate, extend in a sustain electrode pairs direction and are separated from each other. Address electrodes are disposed on a surface of the rear substrate facing the front substrate and have a direction crossing the sustain electrode pairs direction. A front dielectric layer covers the sustain electrode pairs, and has grooves formed in a direction parallel to the sustain electrode pairs direction such that the grooves have slopes in a direction from the rear substrate towards the front substrate, ends of the sustain electrode pairs being located on a lower surface of the front substrate where shadows of the slopes are cast. A rear dielectric layer covers the address electrodes. Phosphor layers are coated in the discharge cells. A discharge gas is filled in the discharge cells.

The grooves may be respectively located between the sustain electrode pairs.

The grooves may expose the front substrate.

The grooves may be extended crossing the discharge cells.

The grooves may be discontinuously formed corresponding to the discharge cells.

The PDP may further include a protective layer to cover the front dielectric layer and the grooves.

According to another exemplary embodiment of the present invention, a PDP is provided having a front substrate and a rear substrate facing each other. Sustain electrode pairs are disposed on a surface of the front substrate facing the rear substrate, extend in a sustain electrode direction and are separated from each other. A dielectric layer covers the sustain electrode pairs, and has grooves formed in a direction parallel to the sustain electrode pairs direction such that the grooves have slopes in a direction from the rear substrate to the front substrate and ends of the sustain electrode pairs are located on a position where the slopes are projected to the front substrate.

The PDP may increase bright room contrast by reducing reflective brightness observed at the front of the panel through increasing the ratio of the black portion at the front of the panel.

### BRIEF DESCRIPTION OF THE DRAWINGS

FIG. 1 is a vertical cross-sectional view of a structure of a conventional AC type PDP.

FIG. 2 is a partially exploded perspective view of a PDP according to an embodiment of the present invention.

FIG. 3 is a cross-sectional view taken along the line III-III of FIG. 2, according to an embodiment of the present invention.

FIG. 4 is an enlarged cross-sectional view of a portion A in FIG. 3, according to an embodiment of the present invention.

FIG. 5 is a partial perspective view of a modified version of an upper plate having discontinuity grooves according to an embodiment of the present invention.

FIG. 6 is a cross-sectional view taken along the line VI-VI of FIG. 5, according to an embodiment of the present invention.

FIG. 7 is an enlarged cross-sectional view of a portion B in FIG. 6, according to an embodiment of the present invention.

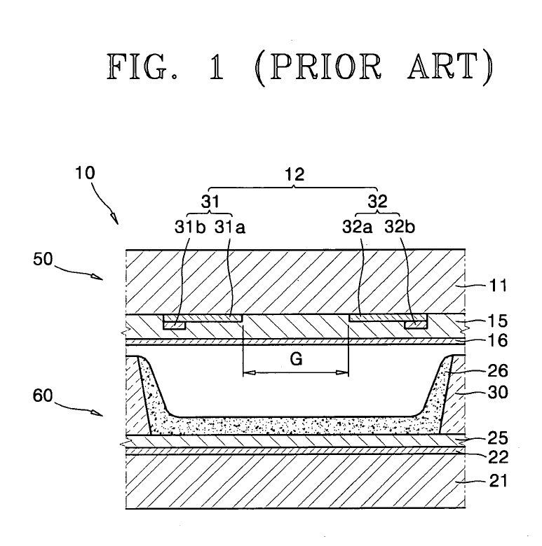

### DETAILED DESCRIPTION

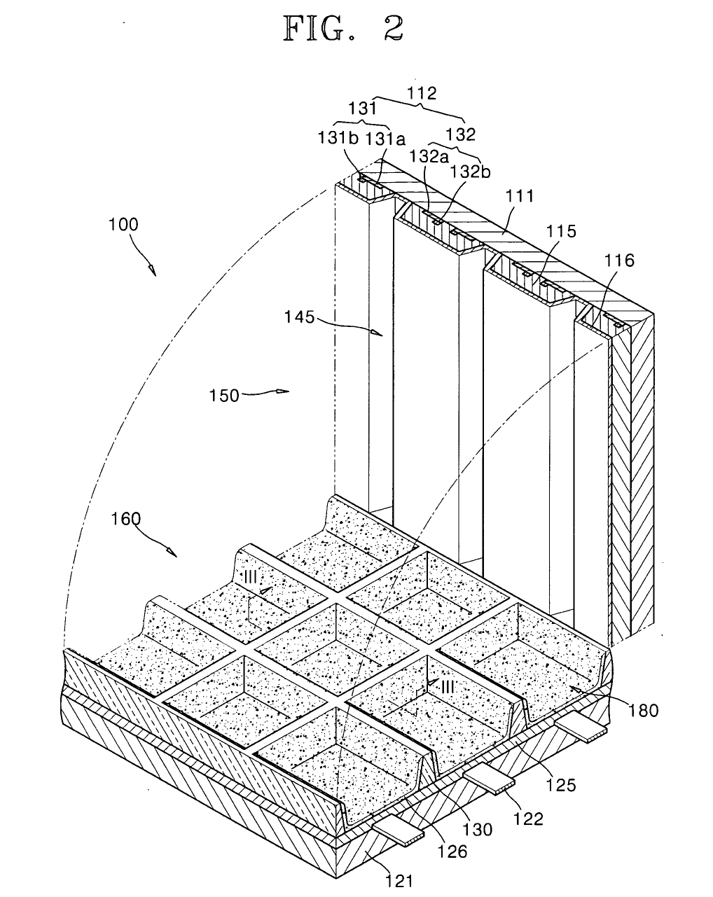

Referring to FIGS. 2, 3 and 4, the PDP 100 includes an upper plate 150 and a lower plate 160 coupled parallel to the upper plate 150. The upper plate 150 includes a front substrate 111, a front dielectric layer 115, sustain electrode pairs 112, and a protective layer 116, and the lower plate 160 includes a rear substrate 121, address electrodes 122, a rear dielectric layer 125, barrier ribs 130, and a phosphor layer 126.

The front substrate 111 and the rear substrate 121 are separated apart, and have a discharge space is defined therebetween. The front substrate 111 and the rear substrate 121 may be formed of a material having high visible light transmittance such as glass. However, the front substrate 111 and/or the rear substrate 121 can be colored to improve bright room contrast.

The barrier ribs 130 are disposed between the front substrate 111 and the rear substrate 121. The barrier ribs 130 can be disposed on the rear dielectric layer 125 according to the manufacturing process. The barrier ribs 130 define the discharge space into a plurality of discharge cells 180, and prevent optical and electrical cross-talk between the discharge cells 180. In FIG. 2, the barrier ribs 130 define the discharge cells 180 in a matrix arrangement having a rectangular horizontal cross-section, but the present invention is not limited thereto. That is, the barrier ribs 130 can define the discharge cells 180 as having a polygonal shape such as a triangle, a pentagon, a circle, or an oval horizontal cross-section, or an open type such as a stripe. Also, the barrier ribs 130 can define the discharge cells 180 to have a waffle or delta shape.

The sustain electrode pairs 112 are disposed on the front substrate 111 facing the rear substrate 121. Each of the sustain electrode pairs 112 denotes an X electrode 131 and a Y electrode 132 formed on a rear surface of the front substrate 111 to cause sustain discharge, and the sustain electrode pairs 112 are arranged parallel to each other and separated apart on the front substrate 111. The X electrode 131 serves as a common electrode, and the Y electrode 132 serves as a scan electrode. In the current embodiment of the present invention, the sustain electrode pairs 112 are formed on the front substrate 111, but the location of the sustain electrode pairs 112 is not limited thereto. For example, the sustain electrode pairs 112 can be disposed a distance away from the front substrate 111 toward the rear substrate 121.

The X electrode 131 and the Y electrode 132 respectively include transparent electrodes 131a, 132a and bus electrodes 131b, 132b. The transparent electrodes 31a, 32a are formed of a conductive transparent material such as indium tin oxide (ITO) that does not block the progress of light emitted from the phosphor material 26 toward the front substrate 11. However, a transparent material such as ITO generally has high resistance. Accordingly, if the sustain electrodes 112 are formed using only the transparent electrodes 131a, 132a, a voltage drop in a length direction is large. Therefore, the consumption of driving power is high and response speed is low. To address these problems, the bus electrodes 131b, 132b formed of a narrow strip of metal are disposed on the transparent electrodes 131a, 132a. The bus electrodes 131b, 132b can be formed of a metal such as Ag, Al, or Cu in a single layer structure, or can be formed of Cr/Al/Cr in a multi-layer structure. The transparent electrodes 131a, 132a and the bus electrodes 131b, 132b are formed using a photo etching method or a photolithography method.

The shapes and locations of the X electrode 131 and the Y electrode 132 are as follows. The bus electrodes 131b, 132b are disposed parallel to each other and separated by a predetermined distance in the unit discharge cell 180, and extend across the discharge cells 180. As described above, the transparent electrodes 131a, 132a are respectively electrically connected to the bus electrodes 131b, 132b, and the rectangular shaped transparent electrodes 131a, 132a are discontinuously disposed in each of the discharge cells 180. First ends of the transparent electrodes 131a, 132a are connected to the bus electrodes 131b, 132b and second ends of the transparent electrodes 131a, 132a are disposed to face a central portion of each of the discharge cells 180.

A front dielectric layer 115 is formed on the front substrate 111 to cover the sustain electrode pairs 112. The front dielectric layer 115 prevents an electrical connection between adjacent X electrodes 131 and Y electrodes 132, and also, prevents the X electrodes 131 and the Y electrodes 132 from being damaged by direct collisions with charged particles or electrons. Also, the front dielectric layer 115 can function to induce charges. The front dielectric layer 115 can be formed of PbO, B₂O₃, SiO₂, and the like.

Grooves 190 may be formed in the front dielectric layer 115 disposed to cover the sustain electrode pairs 112. That is, the grooves 190 may be formed in a direction parallel to the length direction of the sustain electrode pairs 112 so that the grooves 190 can have slopes 191 in a direction from the rear substrate 121 towards the front substrate 111. Ends 192 of the sustain electrode pairs 112 are located on a lower surface of the front substrate 111 where shadows of the slopes 191 are cast.

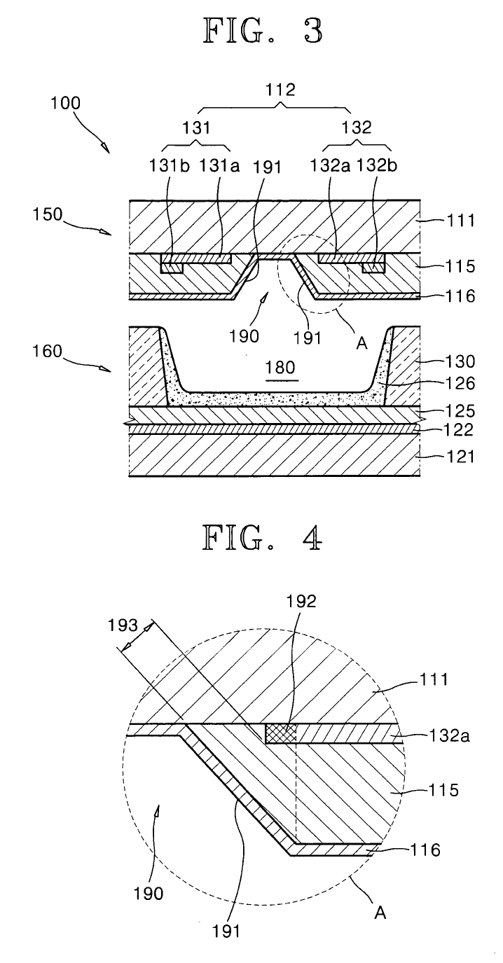

As depicted in FIG. 3, when the front dielectric layer 115 is formed in a ridge structure, the inclination part formed by the slopes 191 appears black when light is emitted from the discharge cells 180 due to scattering of light at the slopes 191. Accordingly, using this characteristic, the black portion can be extended or reduced by controlling the width of the inclination part, and reflective brightness can be reduced by extending the black portion.

To maximize the ratio of the black portion, as depicted in FIG. 3, the slopes 191 may be extended so that end portion 192 of the sustain electrode pairs 112 on a side close to the grooves 190 can be located within the inclination part. Also, in this case, problems of withstand voltage and electrode exposure can be avoided because a distance 193 from an end portion 192 of the sustain electrode pairs 112 to the slope 191 can be sufficiently secured.

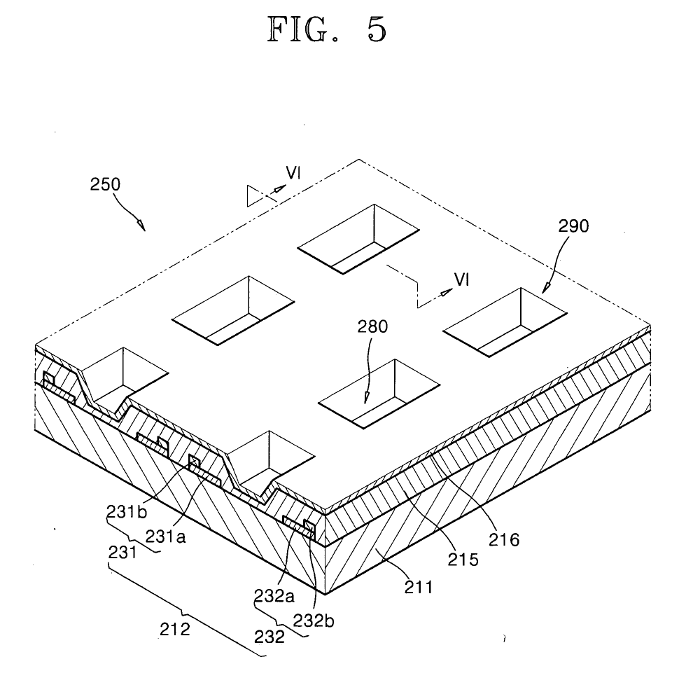

Also, the grooves 190 are formed in the front dielectric layer 115 between the pairs of X electrodes 131 and Y electrodes 132. The grooves 190 are formed to a predetermined depth of the front dielectric layer 115, and the depth of the grooves 190 is determined taking into consideration the possibility of damage of the front dielectric layer 115 by plasma discharge, the arrangement of the barrier ribs 130, the discharge voltage, and the like. For example, in the present embodiment as depicted in FIGS. 2, 3 and 4, the grooves 190 can be formed to expose the front substrate 111. In another embodiment of the present invention as depicted in FIG. 5, a portion of front dielectric layer 215 can be formed on front substrate 211 where grooves 290 are formed.

Referring to FIGS. 2 and 3, one groove 190 is formed corresponding to each discharge cell 180, but the present invention is not limited thereto. That is, a plurality of grooves 190 can be formed to correspond to each of the discharge cells 180. Also, each discharge cell 180 may not necessarily have the same number of grooves 190. For example, red light-emitting discharge cells, green light-emitting discharge cells, and blue light-emitting discharge cells may have a different number of grooves 190.

The transmittance of light to the front is increased since the thickness of the front dielectric layer 115 is reduced by the grooves 190. The grooves 190 according to the present embodiment substantially have a rectangular horizontal cross-section, but the shape of the grooves 190 according to the present invention is not limited thereto, and can have various shapes. Also, the grooves 190 are formed between the sustain electrode pairs 112, thereby readily generating discharge, and as a result, increasing brightness.

Referring to FIG. 2, the grooves 190 extend across the discharge cells 180 between the X electrodes 131 and the Y electrodes 132. In this case, the grooves 190 can serve as exhaust flow channels of impurity gases filled in the discharge space during a gas exhaust process and as inflow channels of a discharge gas during a sealing process.

However, in the upper plate of a PDP as depicted in FIG. 5, the grooves 290 can be formed discontinuously corresponding to each discharge cell 280 in a front dielectric layer 215.

A protective layer 116 may be formed to cover the front dielectric layer 115 and the grooves 190. According to an embodiment of the present invention, if the grooves 190 are formed to expose the front substrate 111, the protective layer 116 would not be formed on the front substrate 111.

That is, the PDP 100 may further include the protective layer 116 covering the front dielectric layer 115. The protective layer 116 prevents the front dielectric layer 115 from being damaged due to collisions with charged particles and electrons during discharge.

Also, the protective layer 116 facilitates plasma discharge by emitting a large amount of secondary electrons during discharge. The protective layer 116 having the above functions is formed of a material having a high secondary electron emission coefficient and high visible light transmittance. The protective layer 116 is formed to be a thin film mainly using sputtering or electron beam deposition after the front dielectric layer 115 is formed.

The address electrodes 122 are disposed on the rear substrate 121 facing the front substrate 111. The address electrodes 122 extend in a direction across the discharge cells 180 to intersect the direction of the X electrodes 131 and the Y electrodes 132.

The purpose of the address electrodes 122 is to generate an address discharge that facilitates the generation of a sustain discharge between the X electrodes 131 and the Y electrodes 132. More specifically, the address electrodes 122 reduce the voltage for generating a sustain discharge. The address discharge is generated between the Y electrodes 132 and the address electrodes 122. When the address discharge is completed, wall charges are accumulated on the X electrodes 131 and the Y electrodes 132, thereby facilitating the generation of sustain discharge between the X electrodes 131 and the Y electrodes 132.

A space formed by the pair of the X electrode 131 and the Y electrode 132 and the address electrode 122 crossing the X and Y electrodes 131, 132 forms a unit discharge cell 180.

A rear dielectric layer 125 covering the address electrodes 122 is formed on the rear substrate 121. The rear dielectric layer 125 is formed of a dielectric that can prevent the address electrodes 122 from being damaged by charged particles and electrons during discharge and can induce charges, for example, PbO, B₂O₃, SiO₂, and the like.

The phosphor layer 126, including red, green and blue phosphor layers, is formed on both sidewalls of the barrier ribs 130 on the rear dielectric layer 125 and on the front surface of the rear dielectric layer 125 where the barrier ribs 130 are not formed. The phosphor layer 126 includes an ingredient that emits visible light by receiving ultraviolet rays. The red phosphor layer formed in the red light-emitting discharge cells includes a phosphor material such as Y(V,P)O₄:Eu, the green phosphor layer formed in the green light-emitting discharge cells includes a phosphor material such as Zn₂SiO₄:Mn, YBO₃:Tb, and the like, and the blue phosphor layer formed in the blue light-emitting discharge cells includes a phosphor material such as BAM:Eu.

A discharge gas in which Ne gas and Xe gas are mixed is filled in the discharge cells 180. When the discharge gas is filled in the discharge cells 180, the front substrate 111 and the rear substrate 121 are coupled to each other using a sealing member such as frit glass formed on edges of the front and rear substrates 111, 121.

Ultraviolet rays are emitted from the discharge gas due to the reduction of an energy level of the discharge gas which is excited during a sustain discharge. The ultraviolet rays excite the phosphor layer 126 coated in the discharge cells 180, and visible light is emitted from the phosphor layers 126 as the energy level of the phosphor layer 126 is reduced. The visible light is transmitted through the front dielectric layer 115 and the front substrate 111 and forms images.

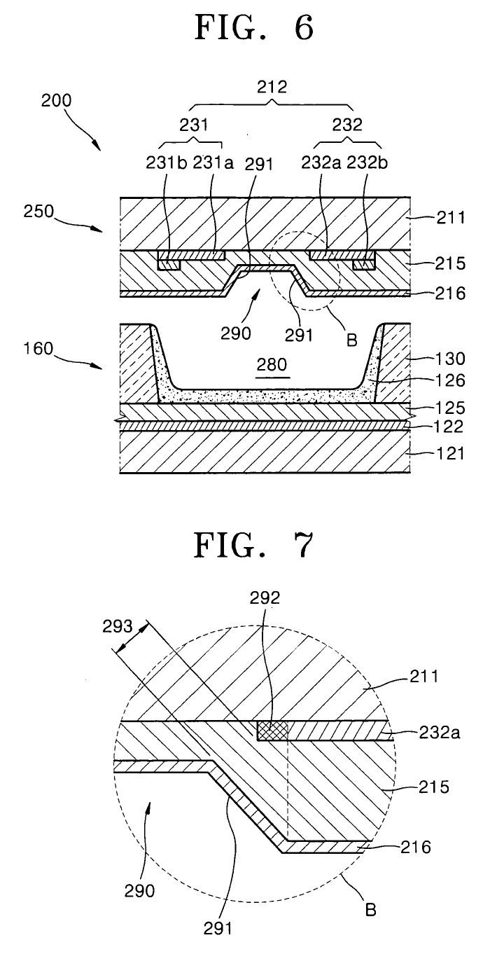

Referring now to FIGS. 5, 6 and 7, a PDP according to an embodiment of the present invention is the same as the PDP depicted in FIGS. 2, 3 and 4 except for portions which will be described hereinafter, and the same reference numerals are used for identical components in the present embodiment and the previous embodiment, and thus, the detailed descriptions thereof will not be repeated.

An upper plate 250 of a plasma display panel according to the present embodiment is depicted. A lower plate (not shown in FIG. 5) can be the same as the lower plate 160 in FIG. 2.

The PDP includes: a rear substrate 121; a front substrate 211 facing the rear substrate 121; barrier ribs 130 which are disposed between the front substrate 211 and the rear substrate 121 and define a plurality of discharge cells 280; sustain electrode pairs 212 disposed on a surface of the front substrate 211 facing the rear substrate 121 extending in a direction and separated from each other; address electrodes 122 disposed on a surface of the rear substrate 121 facing the front substrate 211 to cross the direction of the sustain electrode pairs 212; a front dielectric layer 215 that covers the sustain electrode pairs 212, and has grooves 290 parallel to the sustain electrode pairs 212 so that the grooves 290 can have slopes 291 in a direction from the rear substrate 121 to the front substrate 211 and that ends 292 of the sustain electrode pairs 212 can be located on a position of the front substrate 211 where shadows of the slopes 291 are cast; a rear dielectric layer 125 covering the address electrodes 122; a phosphor layers 126 coated in the discharge cells 280; and a discharge gas filled in the discharge cells 280.

According to the present embodiment of the invention, the grooves 290 in the front dielectric layer 215 are formed discontinuously corresponding to each of the unit discharge cells 280. A protective layer 216 may be formed on the front dielectric layer 215. As discussed above, problems of withstand voltage and electrode exposure can be avoided because a distance 293 from an end portion 292 to the slope 291 can be sufficiently secured.

In a PDP 200 having the above structure, each sustain electrode pair 212 denotes a pair of electrodes 231, 232. Of the sustain electrode pair 212, an electrode is an X electrode 231 that functions as a common electrode, and the other of the sustain electrode pair 212 is a Y electrode 232 that functions as a scanning electrode.

Each of the X electrode 231 and the Y electrode 232 includes transparent electrodes 231a, 232a and bus electrodes 231b, 232b.

In a PDP according to the present invention, the ratio of the black portion at the front of a panel can be increased by forming a ridge type panel and extending slopes so that end portions of electrodes on a discharge gap side can be located within a ridge inclination part.

Accordingly, bright room contrast can be increased by reducing reflective brightness observed at the front of the panel.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a rear substrate;
a front substrate facing the rear substrate;
barrier ribs disposed between the front substrate and the rear substrate and defining a plurality of discharge cells;
sustain electrode pairs disposed on a surface of the front substrate facing the rear substrate, extending in a sustain electrode pairs direction and separated from each other;
address electrodes disposed on a surface of the rear substrate facing the front substrate to cross the sustain electrode pairs direction;
a front dielectric layer covering the sustain electrode pairs and having grooves formed in a direction parallel to the sustain electrode pairs direction such that the grooves have slopes in a direction from the rear substrate towards the front substrate and ends of the sustain electrode pairs being located on a lower surface of the front substrate where shadows of the slopes are cast;
a rear dielectric layer covering the address electrodes;
phosphor layers coated in the discharge cells; and
a discharge gas filled in the discharge cells.

2. The plasma display panel of claim 1, wherein the grooves are respectively located between the sustain electrode pairs.

3. The plasma display panel of claim 1, wherein the grooves expose the front substrate.

4. The plasma display panel of claim 1, wherein the grooves extend across the discharge cells.

5. The plasma display panel of claim 1, wherein the grooves are discontinuously formed corresponding to the discharge cells.

6. The plasma display panel of claim 1, further comprising a protective layer covering the front dielectric layer and the grooves.

7. A plasma display panel comprising:
a front substrate and a rear substrate facing each other;
sustain electrode pairs disposed on a surface of the front substrate facing the rear substrate, extending in a sustain electrode pairs direction and separated from each other; and
a dielectric layer covering the sustain electrode pairs, and having grooves formed in a direction parallel to the sustain electrode pairs direction such that the grooves have slopes in a direction from the rear substrate towards the front substrate and ends of the sustain electrode pairs being located on a lower surface of the front substrate where shadows of the slopes are cast.

8. The plasma display panel of claim 7, wherein the grooves are respectively located between the sustain electrode pairs.

9. The plasma display panel of claim 7, wherein the grooves expose the front substrate.

10. The plasma display panel of claim 7, wherein the grooves extend across the discharge cells.

11. The plasma display panel of claim 7, wherein the grooves are discontinuously formed corresponding to the discharge cells.

12. The plasma display panel of claim 7, further comprising a protective layer covering the front dielectric layer and the grooves.

13. A method of reducing reflective brightness observed at a front of a plasma display panel, the plasma display panel having barrier ribs disposed between a front substrate and a rear substrate defining discharge cells, sustain electrode pairs disposed on the front substrate, address electrodes disposed on the rear substrate in a direction to cross a length direction of the sustain electrode pairs, a front dielectric layer covering the sustain electrode pairs, a rear dielectric layer covering the address electrodes, phosphor layers coating the discharge cells and a discharge gas filling the discharge cells, the method comprising:
forming grooves in the front dielectric layer between respective sustain electrode pairs in a direction parallel to the length direction such that the grooves have slopes in a direction from the rear substrate towards the front substrate; and
locating ends of the sustain electrode pairs on a lower surface of the front substrate where shadows of the slopes are cast.

14. The method of claim 13, wherein the grooves expose the front substrate.

15. The method of claim 13, wherein the grooves extend across the discharge cells.

16. The method of claim 13, wherein the grooves are discontinuously formed corresponding to the discharge cells.

17. The method claim 13, further comprising covering the front dielectric layer and the grooves with a protective layer.
